(19) United States
(12) Patent Application Publication
(10) Pub. No.: US 2022/0080825 A1
(43) Pub. Date: Mar. 17, 2022

(54) FILLING HEAD

(71) Applicant: Röchling Automotive SE & Co. KG, Mannheim (DE)

(72) Inventors: Dieter Kerschbaumer, Tramin (IT); Christoph Ganthaler, Naturns (IT)

(21) Appl. No.: 17/474,352

(22) Filed: Sep. 14, 2021

(30) Foreign Application Priority Data
Sep. 16, 2020 (DE) 10 2020 124 193.3

(51) Int. Cl. B60K 15/035; B60K 15/04

(52) U.S. Cl. CPC B60K 15/035; B60K 15/0406; B60K 2015/048; B60K 2015/03576; B60K 2015/047; B60K 2015/03538

(57) ABSTRACT

A filling head for introducing operating fluid into an operating fluid tank of a motorized vehicle, where the filling head includes:
A filling head housing, where the filling head housing exhibits a delivery-accommodation region for accommodating delivery devices,
A venting structure, which during a transmission of operating fluid through the filling head housing allows transmission of gas,
Where the delivery-accommodation region exhibits a plug-in nozzle extending along a virtual nozzle path with a plug-in orifice through which an accommodating space is accessible,
Where in the filling head housing, at an axial magnet distance from the plug-in orifice, there is arranged a magnet arrangement,
Where the venting structure includes a channel arrangement which is bounded by an inner wall of the plug-in nozzle and by an outer wall of the plug-in nozzle, wherein from the plug-in orifice as far as and into the extension region of the magnet arrangement there proceeds a gas-impermeable boundary surface which bounds the accommodating space radially outward, where a cross-sectional area enclosed by the boundary surface and orthogonal to the nozzle path is at least not larger in the extension region of the magnet arrangement than in a reference region located between the magnet arrangement and the plug-in orifice.

This Application claims priority in German Patent Application DE 10 2020 124 193.3 filed on Sep. 16, 2020, which is incorporated by reference herein.

The present invention concerns a filling head for introducing operating fluid into an operating fluid tank of a motorized vehicle and for venting the operating fluid tank when introducing operating fluid into it.

### BACKGROUND OF THE INVENTION

A generic filling head is known from DE 10 2013 016 684 A1 or the related WO 2015/052166 A.

Such filling heads are known generally in the automotive industry. They serve in the case discussed here preferably for filling a urea tank with an aqueous urea solution. In principle, however, the operating fluid can be an arbitrary operating fluid of a motorized vehicle.

The filling head comprises a filling head housing which exhibits a delivery-accommodation region configured for temporally transient accommodation of various delivery devices.

Known delivery devices include, for example, spigots which at service stations or generally at tapping stations form the output section of a motorized conveyor device which conveys the operating fluid from a large operating fluid reservoir whose capacity considerably exceeds the usable tank volume of a single vehicle. Further known delivery devices include necks of storage containers, in particular of bottles and canisters, through which a defined manually manageable operating fluid reservoir can be emptied into the tank. One example of such known manually manageable operating fluid reservoirs, whose capacity is normally less than or approximately equal to the usable tank volume of a motorized vehicle, is the Kruse bottle. In addition to the Kruse bottle, other bottles are also available in the marketplace.

During a delivery process, output ends of the particular delivery devices accommodated in the accommodating space dispense operating fluid into the filling head, from where the operating fluid is fed via an outlet port of the filling head housing into a tank connected with the filling head via a filling line.

Since regardless of the manufacturer, delivery devices have to be able to fill a large number of operating fluid tanks of various vehicles, delivery devices are standardized in their dimensions at least at their end sections that have to interconnect with vehicle-side filling heads. Shapes and dimensions of filling systems are defined in the ISO Standards 22241-4 and 22241-5.

Because of this standardization, it is permissible in the present case to refer to these delivery devices without them necessarily having to be defined or even be part of the technical solution described here, since due to the standardization the appropriate average expert is familiar with the dimensions relevant for filling heads.

The filling head housing is therefore configured for transmitting operating fluid in a delivery sense from the delivery-accommodation region along an operating fluid delivery route to the outlet port of the filling head housing arranged in the delivery sense downstream of the delivery-accommodation region.

Regardless of local flow directions of the operating fluid during a filling and/or delivery process respectively of an operating fluid tank—hereinunder also referred to in short as ‘tank’—connected fluid-mechanically with the filling head, the term ‘delivery sense’ denotes a resulting flow direction over the entire filling head away from an inlet end distal from the tank on the fully assembled motorized vehicle to an outlet end of the filling head proximate to the tank. Due to the more or less complicated inner structure of a filling head, operating fluid transmitted through the filling head can flow locally in different flow directions at different locations. In the delivery operation, however, during which operating fluid is filled through the filling head into the tank on the motorized vehicle, the operating fluid always flows in the delivery sense through the filling head.

The filling head housing further comprises a venting structure, which during a transmission of operating fluid through the filling head housing in the delivery sense, allows a transmission of gas in a venting sense that is opposite to the delivery sense.

It is generally known that when filling a tank with liquid, the liquid introduced into the tank has to be able to displace gas originally present in the tank in order to achieve undisturbed and properly complete filling of the tank. In the filled tank there unavoidably remains a gas volume above the operating fluid filled in. The pressure of this gas should differ quantitatively only insignificantly from the atmospheric pressure. The filling of the tank with operating fluid and the venting of the gas displaced by the operating fluid naturally take place in counterflow, i.e. the operating fluid flows in the delivery sense towards the tank, whereas the displaced gas flows in the venting sense away from the tank. Once again, this should not depend on concrete local flow directions of the gas. For the ‘venting sense’, therefore, the same applies mutatis mutandis as stated above for the delivery sense: the venting sense indicates the resulting flow direction of the displaced gas via the entire filling head away from the tank. The starting and/or end points of the flow routes of the gas and the operating fluid need not necessarily coincide.

The delivery-accommodation region of the filling head exhibits a plug-in nozzle with a plug-in orifice, extending along a virtual nozzle path. The virtual nozzle path is conceived here as penetrating centrally through the length of the plug-in nozzle. The nozzle path is the basis of a coordinate system for describing the filling head. Axial directions proceed along the nozzle path, radial directions proceed orthogonally to it, and circumferential directions proceed around the nozzle path. The nozzle path can in principle be an arbitrarily curved, possibly even multiply curved, path. Preferably, however, the nozzle path is a straight nozzle axis.

Through the end-side plug-in orifice of the plug-in nozzle there is accessible an accommodating space for temporally transient accommodation of the delivery device. The accommodating space is connected fluid-mechanically with the outlet port, so that via the delivery device accommodated in the accommodating space, operating fluid dispensed by it can arrive at the outlet port and from there finally into the tank likewise connected fluid-mechanically with the filling head.

In the filling head housing there is arranged at a distance from the plug-in orifice to be measured along the nozzle path and therefore axially, a magnet arrangement whose magnetic field acts on the operating fluid's delivery route. The distance of the magnet arrangement from the plug-in orifice is denoted in the present application by ‘magnet distance’.

The magnet distance is normally so dimensioned that the magnetic field produced by the magnet arrangement acts on a magnetic field-sensitive valve in a spigot plugged into the accommodating space. Preferably, the magnet arrangement is an annular magnet, where the delivery route penetrates through the annular magnet. Alternatively, the magnet arrangement can exhibit at least two or more magnets arranged around the delivery route. The magnet arrangement preferably comprises only permanent magnets, in order to avoid a power supply to the filling head for providing current to an electromagnet.

The venting structure comprises a channel arrangement, which at least along an axial section of the plug-in nozzle is bounded radially inwards by an inner wall structure with an inner wall of the plug-in nozzle facing towards the accommodating space and radially outwards by an outer wall structure with an outer wall of the plug-in nozzle facing away from the accommodating space. The channel arrangement extends inside the material forming the tubular plug-in nozzle such that for forming the channel arrangement, installation space is used which in any case is occupied by the plug-in nozzle. Thereby, the installation space utilized by the filling head can be kept small. The channel structure in the material of the plug-in nozzle is connected via the rest of the venting structure with a gas volume in a tank connected fluid-mechanically with the filling head. This fluid-mechanical connection can be formed by a filling line leading from the outlet port to the tank and/or by a separate venting line. The filling line is conceived in the first instance for transmitting operating fluid from the filling head to the tank, where due to the turbulent filling situation during a delivery process, normally gas also flows in the filling line. A separate venting line is conceived in the first instance as a gas-conveying line, where likewise due to the turbulent filling situation normally liquid also moves in the venting line during a delivery process.

Further filling heads are known for example from WO 2020/020696 A2, EP 2 668 055 A, and EP 2 719 566 A.

In many known filling heads, channels go completely around the magnet arrangement such that a fluid, such as gas or operating fluid, can form a kind of turbulent flow around the magnet arrangement, which can impede venting during a delivery process. According to the aforementioned standardization not only of the delivery devices but also of the delivery process itself, in the case of aqueous urea solution as the preferred operating fluid, delivery devices supply at a liquid volume flow rate of 20 to 40 l/min. Despite the fundamental compressibility of the gas displaced by the delivered operating fluid, the venting volume flow is at the same order of magnitude. Given the fundamentally small construction volume of the filling heads discussed here, therefore, even minor disturbances of the venting process play a part.

### SUMMARY OF THE INVENTION

It is the task of the present invention to improve the known filling heads.

This task is solved by the present invention for a generic filling head in such a way that from the plug-in orifice there proceeds as far as and into the axial extension region of the magnet arrangement a gas-impermeable boundary surface that is formed at least also by the inner wall and bounds the accommodating space radially outwards, where a cross-sectional area enclosed by the boundary surface and orthogonal to the nozzle path in a region of the boundary surface located in the extension region of the magnet arrangement, is at least not larger than in a reference region located between the magnet arrangement and the plug-in orifice, where the reference region begins at an axial distance of 10% of the magnet distance from the plug-in orifice and ends at an axial distance not exceeding 50% of the magnet distance from the plug-in orifice.

The gas-impermeable boundary surface physically divides the accommodating space from the channel structure, such that an overflow of gas or operating fluid into the region of the accommodating space between the accommodating space and the channel structure is precluded. The boundary surface can be defined solely by the inner wall of the plug-in nozzle or by the inner wall and an outer surface of a further component. The boundary surface can therefore exhibit a joint line, if it is gas-tight. The boundary surface proceeds in a circumferential direction completely around the nozzle path and proceeds continuously in an axial direction at least from the reference region as far as and into the axial extension region of the magnet arrangement. The boundary surface proceeds preferably starting from the plug-in orifice at least as far as the cross-sectional area in the axial extension region of the magnet arrangement.

By configuring the accommodating space with a greater cross-sectional area nearer to the plug-in orifice, easy introduction of the delivery device into the accommodating space without laborious threading caused by tight size tolerances between the delivery device and the accommodating space can be guaranteed.

By configuring the accommodating space with a smaller cross-sectional area in the region of the axial extension of the magnet arrangement, fluid flow in the gap space between the boundary surface and the outer surface of a delivery device that lies opposite to it during a delivery process can already be prevented in the region of the magnet arrangement. Thereby it can be made certain that during a delivery process the entire venting can take place without being influenced by flow processes at the outlet end of the delivery device and further without being influenced by already prevented flow processes in the gap space between delivery device and inner wall of the plug-in nozzle.

The reference region should begin here only at an axial distance from the plug-in orifice which is equal to 10% of the magnet distance, so that beveled edges and insertion chamfers configured at the plug-in orifice, which are meant to facilitate introduction of the delivery device into the accommodating space, are left out of consideration.

Preferably, the reference region ends at a distance from the plug-in orifice equal to 30% of the magnet distance, especially preferably at a distance equal to 20% of the magnet distance.

Given sufficiently tight tolerance of the clear width of the inner wall in the reference region and the resulting small radial gap size between the delivery device and the boundary surface, it can suffice if the cross-sectional area in the extension region of the magnet arrangement corresponds to the cross-sectional area in the reference region. With a radial gap size of approximately 0.25 mm to 0.5 mm, the gap width is so small that the flow resistance developing in the gap to venting flow during a delivery process is insurmountable. In order to achieve both the simplest possible introduction of the delivery device into the accommodating space and the most reliable possible sealing of the gap space between the delivery device and the structure of the filling head surrounding it radially outside, it is in contrast preferable for the cross-sectional area in the extension region of the magnet arrangement to be smaller than in the reference region. Then in a region of the accommodating space that is located nearer to the plug-in orifice, the delivery device can be conveniently introduced into it and the gap space that unavoidably exists between the delivery device and the structure of the filling head surrounding it can be closed fluid-mechanically in a region located in the extension region of the magnet arrangement.

Due to the circumstance that during a delivery process no appreciable venting flow can develop in a gap space 0.25 mm to 0.5 mm wide around the delivery device, retaining the gap space in the region of the axial extension of the magnet arrangement at the aforementioned order of magnitude can already suffice in order to prevent venting flow in the gap space and shift it completely to the channel arrangement. Due to the higher reliability of physically preventing venting flow in the gap space compared with an open gap space with the above radial gap widths, however, a physically closed gap space in the axial extension region of the magnet arrangement is preferable. Therefore according to a preferred further development of the present invention, there is provided in the extension region of the magnet arrangement a sealing structure encircling the nozzle path and projecting radially inwards towards the nozzle path. The sealing structure is dimensioned here in such a way that with a delivery device introduced into the accommodating space, the sealing structure is in abutting engagement with an outer surface of the delivery device. The sealing structure encloses the smaller cross-sectional area of the boundary surface located in the axial extension region of the magnet arrangement.

Preferably, the cross-sectional area enclosed by the sealing structure is smaller than a cross-sectional area which is enclosed by the outer surface of that section of the delivery device which with a properly introduced delivery device is arranged in the axial region of the sealing structure. Then the delivery device deforms the sealing structure elastically radially outwards, such that the sealing structure abuts especially securely under the restoring effect of its elastic deformation onto the outer surface of the delivery device and seals against it. For the same reason, the cross-sectional area enclosed by the sealing structure is preferably the smallest cross-sectional area of the boundary surface in the accommodating space.

Preferably, the cross-sectional surfaces are circularly edged cross-sectional surfaces, such that blocking the gap space between the delivery device and the plug-in nozzle to a venting flow does not depend on the orientation of the delivery device in the circumferential direction about the nozzle path.

Preferably, at least the plug-in nozzle of the filling head, especially preferably the complete filling head housing, is fabricated as a synthetic injection molding component.

In order to realize the smallest possible number of components necessary for producing the filling head, at least one section of the inner wall structure of the plug-in nozzle can be configured integrally with at least one section of the outer wall structure of the plug-in nozzle. Then normally the channel arrangement should be produced by means of cores and/or sliders as the case may be in the volume region of the material of the plug-in nozzle. Depending on other physical design of the plug-in nozzle, this can lead to difficulties. Therefore, alternatively it can be conceivable that at least one section of the inner wall structure of the plug-in nozzle is configured as a separate inner wall component separate from at least one section of the outer wall structure of the plug-in nozzle.

Based on the described configuration of the channel arrangement by means of sliders and/or cores in the case of integral configuration of the inner wall structure and outer wall structure of the plug-in nozzle, especially an axial section of the plug-in nozzle exhibiting the channel arrangement can be formed with the outer wall structure and an inner wall component configured separately from it. Since the use of several cores, each with a relatively small core and/or slider cross-section respectively, becomes problematic with increasing length of the core and/or slider respectively, one part of the plug-in nozzle can exhibit an inner wall structure configured integrally with the outer wall structure and a channel arrangement section arranged in between. Another part of the plug-in nozzle can exhibit a further section in which the inner wall structure is configured at an inner wall component separate from the outer wall structure. Due to the simpler assembly, however, preferably the inner wall structure is configured over its entire length either integrally with the outer wall structure or at an inner wall component separate from it.

In order that the channel arrangement exhibit a flow cross-section adequate for conducting the gas displaced during a delivery process to the external environment in the venting sense during the available time, the entire flow cross-section of the channel arrangement preferably covers more than 100 mm², especially preferably more than 110 mm². On the other hand, so as not to weaken the plug-in nozzle structurally as a result of the channel arrangement configured in it, the entire flow cross-section of the channel arrangement preferably covers less than 150 mm², especially preferably less than 130 mm².

For the most defined guiding possible of the operating fluid dispensed by the delivery device during the delivery process, there can be arranged in the filling head housing, in the region between the magnet arrangement and the outlet port, a flow-guiding component with a flow-guiding wall proceeding along the operating fluid delivery route. A separate configuration of the inner wall structure of the plug-in nozzle at a separate inner wall component is possible without increasing the total number of components for fabricating the filling head, if the inner wall structure is configured integrally with the flow-guiding component.

An inner wall structure exhibiting the inner wall of the plug-in nozzle, be it an inner wall structure configured integrally with the outer wall structure or an inner wall component configured separately from the outer wall of the plug-in nozzle, can support the magnet arrangement axially. It can exhibit an axial end stop located on the side of the magnet arrangement facing towards the plug-in orifice for limiting axial movement of the magnet arrangement. In particular when the inner wall structure is configured integrally with the flow-guiding component, it can also exhibit an axial end stop and/or an axial support structure respectively on the side of the magnet arrangement facing towards the outlet port. Regardless of whether or not the flow-guiding component exhibits a section of the inner wall structure of the plug-in nozzle, the flow-guiding component can always exhibit an axial support structure extending away radially from the nozzle path and/or the delivery route respectively, onto which the magnet arrangement abuts and/or at which the magnet arrangement is secured against axial movement.

According to a first advantageous further development of the present invention, the sealing structure can be configured integrally with the inner wall structure of the plug-in nozzle, for instance as an injection molding flash which was deliberately configured and left in place at the injection-molded inner wall structure.

A larger number of components is, indeed, obtained according to a second advantageous further development of the present invention, in which the sealing structure is configured at a sealing component configured separately from the plug-in nozzle. However, the separately configured sealing component can be matched optimally to its task and to its deployment environment spatially-physically and in terms of choice of material. A section of an outer surface of the sealing component then contributes to the formation of the boundary surface.

A solution lying between the aforementioned designs is formed by the use of a two-component injection molding process for fabricating a sealing structure firmly bonded and/or positively connected with the inner wall structure, where the inner wall is formed through injection molding by a first material and the sealing structure by a second material different from the first one. Likewise the sealing component can be injected onto the magnet arrangement, preferably on its side facing towards the plug-in orifice.

A sealing component configured separately from the inner wall structure is preferably fixed axially and preferably also radially between the side of the magnet arrangement pointing towards the plug-in orifice on the one hand and the inner wall structure and/or the outer wall structure on the other.

According to a first preferred embodiment, the sealing structure can be formed by a sealing lip projecting radially inward. The advantage of a sealing lip consists in ensuring the sealing of the gap space between the delivery device and the structure of the filling head surrounding it radially outside with minimal cost of material and small necessary elastic restoring forces for securing the sealing abutting engagement of the sealing lip with the delivery device. Preferably the sealing lip encloses the cross-sectional area located in the axial extension region of the magnet arrangement and seals against a delivery device in the axial extension region of the magnet arrangement.

According to a second preferred embodiment, the sealing structure can be formed by a radially inward projecting vertex section of a bellows structure. The advantage of the bellows structure consists in the fact that the bellows folds, normally conical bellows folds, going out from the radially inward projecting vertex, can physically cover a radially inner surface area of the magnet arrangement facing towards the delivery route and/or accommodating space respectively and screen it against the delivery device. Preferably the vertex section encloses the cross-sectional area located in the axial extension region of the magnet arrangement and seals against a delivery device in the axial extension region of the magnet arrangement.

Quite fundamentally, for physical screening of the magnet arrangement against a further structure facing it at a radial distance, a structure section connected with the inner wall structure of the plug-in nozzle can extend over the entire axial length of the magnet arrangement.

For especially simple but effective fixing of the magnet arrangement in the filling head, the structure section can embrace the magnet arrangement at least at one axial longitudinal end of the magnet arrangement. Preferably the structure section exhibits radially springy locking lugs, against whose elastic pre-tensioning force the magnet arrangement can be locked to the structure section in the radial direction. By means of the locking engagement thus produced, the magnet arrangement is arranged in positive engagement with the structure section.

In order to protect the magnet arrangement from the delivery device, in particular from its body's edges, the structure section can go past the magnet arrangement radially on the inside. Preferably but not necessarily, the structure section then exhibits the aforementioned bellows structure.

Alternatively or additionally, the structure section can embrace the magnet arrangement radially on the outside, which makes possible a smallest possible air gap between the magnet arrangement and the valve device in a delivery device influenced by it.

According to an embodiment of the invention, the channel arrangement can penetrate through the plug-in nozzle up to the plug-in orifice. The plug-in nozzle can exhibit in the region of the plug-in orifice a front surface surrounding the plug-in orifice, where the channel arrangement leads into the front surface. The openings of the channel arrangement in the front surface can be closed off by a cap arranged between delivery processes at the plug-in nozzle, whereby the content of the tank is protected against drying out via the venting structure.

In some cases, there may not be sufficient component area available at the front surface of the plug-in nozzle for configuring the at least one opening of the channel arrangement. In this case, or in the case that in addition to front-end venting a further venting cross-section is desired, the channel arrangement can, at an axial distance from the plug-in orifice, lead into an outer wall formed from the outer wall structure of the plug-in nozzle. In doing so, the at least one opening of the channel arrangement should be situated in the outer wall of the plug-in nozzle in such a way that the opening is closed off between delivery processes by a cap arranged at the plug-in nozzle, in order to protect the content of the tank against gradual drying out through the venting structure.

On the outer wall structure of the plug-in nozzle there can be provided an outer thread. It can serve to interact with an inner thread of at least one of the delivery devices for its positional stabilization at the plug-in nozzle and/or with a filling head cap covering the plug-in orifice. Normally spigots have no inner thread. Usually storage containers have couplings with an inner thread, which are screw-mountable on the outer thread of the plug-in nozzle. Likewise, usually only spigots exhibit the aforementioned magnetic field-sensitive valves, bottles and canisters in contrast do not.

A practical and elegant solution for venting via the outer wall of the plug-in nozzle can be realized by providing at the base of the outer thread at least one opening, by means of which the channel arrangement leads into the outer wall. This at least one opening can be closed off between the delivery processes by the cap mentioned above as a ‘filling head cap’, which is screw-mountable on the outer thread.

With the above measures it can be ensured that the channel arrangement is connected fluid-mechanically only radially outside past the magnet arrangement with an inner volume of the filling head housing located on the side of the magnet arrangement facing towards the outlet port. As a result, there are available clear venting routes for venting the tank during a delivery process. Venting through the gap space between the delivery device and the structure of the filling head surrounding it can therefore be dispensed with.

These and other objects, aspects, features and advantages of the invention will become apparent to those skilled in the art upon a reading of the Detailed Description of the invention set forth below taken together with the drawings which will be described in the next section.

### BRIEF DESCRIPTION OF THE DRAWINGS

The invention may take physical form in certain parts and arrangement of parts, a preferred embodiment of which will be described in detail and illustrated in the accompanying drawings which forms a part hereof and wherein:

FIG. 1 A rough schematic longitudinal section view of a first embodiment of a filling head of the present invention,

FIG. 2 A rough schematic longitudinal section view of an inlet region of a second embodiment of a filling head of the present invention,

FIG. 3 A rough schematic longitudinal section view of an inlet region of a third embodiment of a filling head of the present invention,

FIG. 4 A rough schematic longitudinal section view of an inlet region of a fourth embodiment of a filling head of the present invention,

FIG. 5 A rough schematic longitudinal section view of an inlet region of a fifth embodiment of a filling head of the present invention,

FIG. 6 A rough schematic longitudinal section view of an inlet region of a sixth embodiment of a filling head of the present invention,

FIG. 7 A rough schematic longitudinal section view of an inlet region of a seventh embodiment of a filling head of the present invention, and

FIG. 8 A rough schematic longitudinal section view of an inlet region of an eighth embodiment of a filling head of the present invention,

### DESCRIPTION OF PREFERRED EMBODIMENTS

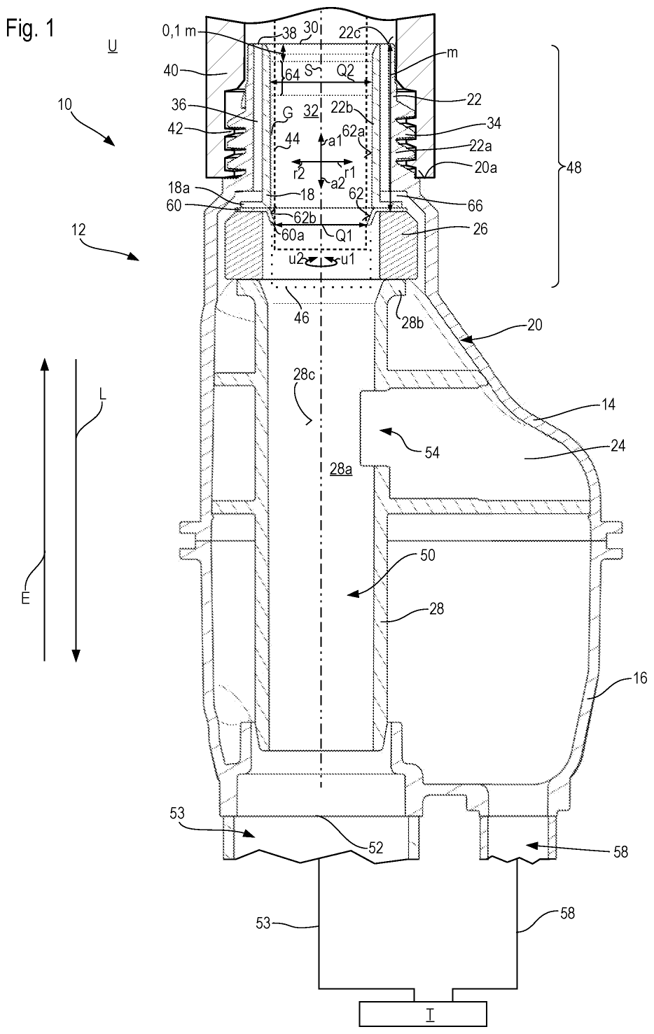

Referring now to the drawings wherein the showings are for the purpose of illustrating preferred and alternative embodiments of the invention only and not for the purpose of limiting the same, FIG. 1 depicts in rough schematic form a first embodiment of a filling head of the present application in longitudinal section, labeled generally as 10. The filling head exhibits a filling head housing 12, which in the present example consists of three housing components 14, 16, and 18 jointed with one another. The housing components 14, 16, and 18 are made of a thermoplastic synthetic by injection molding and are welded or glued with one another at their connecting regions facing towards each other. The synthetic material of at least one housing component 14, 16, and 18, preferably of all housing components 14, 16, and 18, can be filled, for example with glass fibers, in order to increase the strength of the synthetic and thus of the respective housing component.

The filling head housing 12 exhibits a main body 20, from which a plug-in nozzle 22 projects along a virtual nozzle path S forming a straight nozzle axis. The main body 20 surrounds a main volume 24 of the filling head housing 12. In the main volume 24 at its inlet-side end there is arranged a preferably annular permanently magnetized magnet arrangement 26.

In the main volume 24 on the side of the magnet arrangement 26 which in operation is nearer the tank there is arranged a flow-guiding component 28. The flow-guiding component 28 can contribute to the axial, where applicable also to the radial fixing of the magnet arrangement 26 in the main volume 24. The flow-guiding component 28 is clipped, welded, or glued with the housing component 14.

The nozzle path S defines axial directions a1 and a2, radial directions r1, r2, and circumferential directions u1 and u2.

The plug-in nozzle 22 exhibits a plug-in orifice 30, through which an accommodating space 32 surrounded radially outside both by the plug-in nozzle 22 and by the magnet arrangement 26 is accessible. The magnet arrangement is situated at a magnet distance m from the plug-in orifice 30.

The plug-in nozzle 22 exhibits at its outer wall structure 22a, which is formed by the housing component 14 and configures an outer wall facing away from the accommodating space 32, an outer thread 34. The outer thread 34 extends, starting from an end surface 20a which forms a tank-remote longitudinal end of the main body 20 of the filling head housing 12, over more than half of the axial length of the plug-in nozzle 22. Alternatively, the outer thread can begin only at a distance from the end surface 20a and accordingly exhibit fewer turns.

Between its outer wall structure 22a and its inner wall structure 22b that configures an inner wall, there is configured at the plug-in nozzle a channel arrangement 36 which reaches in the plug-in nozzle 22 in the axial direction up to an end wall 22c which surrounds the plug-in orifice and there in at least one opening 38, preferably in a plurality of openings 38, leads to the external environment U.

For better understanding, FIG. 1 depicts a union coupling 40 with an inner thread 42 configured therein screwed together with the outer thread 34. The union coupling 40 is part of a storage container neck that is to be emptied manually through the filling head 10. A ready-for-delivery neck 44 of the storage container, to which the union coupling 40 also belongs, is indicated in rough schematic form in FIG. 1 by a dotted line in the accommodating space 32.

Just like the union coupling 40, a cap embracing the plug-in nozzle 22 outside can be secured by being screwed on detachably on the outer thread 34.

A ready-for-delivery spigot 46 arranged in the accommodating space 32 is depicted by a dotted line in rough schematic form, in comparison with a ready-for-delivery neck 44 as a possible further delivery device. The spigot 46 extends along the nozzle path S from the plug-in orifice 30 beyond the axial position of the magnet arrangement 26, such that it is ensured that the magnetic field produced by the magnet arrangement 26 can act on a valve device arranged in the spigot 46, in order to open it automatically for the passage of operating fluid given proper arrangement of the spigot 46 in the delivery-accommodation region 48 of the filling head 10. Naturally, only either one neck 44 or one spigot 46 at a time can be accommodated as a delivery device in the accommodating space 32.

Quite fundamentally, the accommodating space 32 and the main volume 24 define a delivery route 50 inside the filling head 10, through which during a delivery process there flows operating fluid dispensed by a ready-for-delivery delivery device 44 or 46, in the delivery sense L in the direction from the plug-in orifice 30 towards the outlet port 52. The gas displaced during the delivery process from the tank T connected to the filling head 10 by the operating fluid flowing in the delivery sense L, flows in contrast through the filling head 10, i.e. at least through a section of the main volume 24 and the channel arrangement 36, in a venting sense E opposite to the delivery sense L. The tank T is depicted in rough schematic form only in FIG. 1, solely for the sake of completeness.

To the outlet port 52 there links a filling line 53, which connects the outlet port 52 with the tank T.

The flow-guiding component 28 which follows the magnet arrangement 26 in the delivery sense L, serves particularly for conducting in the delivery sense L operating fluid dispensed by the delivery device 44 or 46 through the filling head 10. However, the flow-guiding component 28 exhibits for the venting of the tank T which is connected fluid-mechanically with the filling head 10 at least one opening 54 penetrating through the flow-guiding component 28 and its flow-guiding surface 28c, such that sections of the main volume 24 outside the flow-guiding component 28 are also reached by operating fluid during a delivery process and consequently can be part of the delivery route 50.

The filling head 10 exhibits a venting line 58, which comes out of the housing component 16. Alternatively, the venting line 58 can also come out of the housing component 14 or a section of the venting line 58 coming out of the main body 20 can be configured in complementary parts through both housing components 14 and 16. In the housing component 16, the venting line 58 leads into the main volume 24. Through the at least one opening 54 in the flow-guiding component 28, displaced gas flowing via the venting line 58 into the main volume 24 can reach the inner flow volume 28a of the flow-guiding component 28 located inside the flow-guiding surface 28c. As a result, pressure equalization between the flow volume 28a and the part of the main volume 24 surrounding the flow-guiding component 28 can be achieved.

In the depicted first embodiment example of FIG. 1, the inner wall structure 22b of the plug-in nozzle 22 is configured at the inner wall component 18, which is fabricated physically separate from the housing component 14 forming the outer wall structure 22a with the outer wall of the plug-in nozzle 22. At the housing component 14 and/or at the inner wall component 18 there can be formed ribs projecting radially inward and/or radially outward respectively, which position the inner wall component 18 radially relative to the housing component 14, i.e. in particular center it relative to the outer wall structure 22a, and which subdivide the channel arrangement 36 into a plurality of single channels following each other in the circumferential direction around the nozzle path S.

The channel arrangement 36 exhibits a total cross-sectional area of preferably between 110 and 130 mm², in order to be able to guarantee venting of the tank T during a delivery process with a volume flow of 20 to 40 l/min of operating fluid in the delivery direction L.

Between the inner wall component 18 and the magnet arrangement 26 there is arranged a sealing component 60. The sealing component 60 abuts gap-free on a support structure 18a configured integrally at the inner wall component 18 as an encircling radial projection. The support structure 18a forms an axial end stop of the magnet arrangement 26, which physically prevents the magnet arrangement 26 approaching the plug-in orifice 30.

Likewise, at the flow-guiding component 28 there can be configured a support section 28b, once again as an encircling radial projection, which forms a physical barrier to movement of the magnet arrangement 26 towards the outlet port 52. The magnet arrangement 26 can therefore be fixed in its axial mobility by the support structures 18a and 28b, where applicable with an intermediate arrangement of the sealing component 60.

Likewise, the sealing component 60 abuts gap-free on the front surface of the magnet arrangement 26 facing towards the plug-in orifice 30.

From the sealing component 60 there protrudes a sealing lip 60a into the accommodating space 32. The sealing lip 60a located in the axial extension region of the magnet arrangement 26 exhibits a cross-sectional area Q1 orthogonal to the nozzle path S, which is smaller than the cross-sectional areas of the delivery devices 44 and 46 in the sections which with a ready-for-delivery delivery device 44 and/or 46 respectively arranged in the accommodating space 32 are arranged at the axial arrangement location of the sealing lip 60a. The sealing lip 60a, therefore, seals in the region of the longitudinal extension of the magnet arrangement 26 along the nozzle path S a gap space G which is present between the delivery device 44 and/or 46 respectively and the structure of the filling head 10 which surrounds the delivery device 44 and/or 46 respectively radially outside towards the plug-in orifice 30.

The inner wall 62a of the plug-in nozzle 22 and the surface 62b facing towards the nozzle path S of the section of the sealing component 60 exhibiting the sealing lip 60a and protruding into the accommodating space 32 form together a closed gas-impermeable boundary surface 62 bounding the accommodating space 32 radially outwards.

The cross-sectional area Q1 is here smaller than the cross-sectional area Q2 in the reference region 64, which begins at a distance of 10% of the magnet distance m from the plug-in orifice 30 and ends at a distance of for example 30% of the magnet distance m from the plug-in orifice 30.

The larger cross-sectional area Q2 guarantees that a delivery device 44 and/or 46 respectively can be introduced comfortably through the plug-in orifice 30 into the accommodating space 32. The smaller cross-sectional area Q1 guarantees the sealing of the gap space G described above.

Venting of the gas displaced from the tank T during a delivery process takes place, therefore, exclusively via the channel arrangement 36, to with radially outside past the magnet arrangement 26 in an annular chamber 66 between the section of the housing component 14 forming the outer wall structure 22a of the plug-in nozzle 22 and the support structure 18a of the inner wall component 18, from where the channel arrangement 36 proceeds through the material of the plug-in nozzle 22 up to its opening 38.

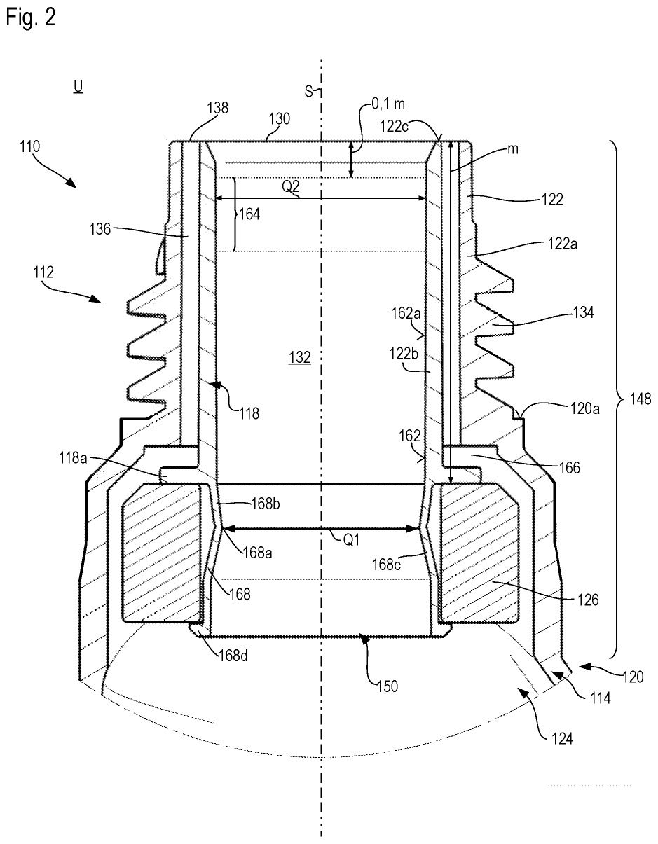

FIG. 2 depict in rough schematic form a second embodiment of the invention's filling head 110 in longitudinal section. Identical and functionally identical components and component sections as in the first embodiment are labeled in the second embodiment with identical reference labels, but increased numerically by 100. The second embodiment shall be described hereunder only in so far as it differs from the first embodiment, to whose description otherwise reference is made expressly also for elucidating the second embodiment.

The second embodiment exhibits, configured integrally with the inner wall structure 122b, a structure section 168 in the form of a bellows structure protruding from the inner wall structure 122b in the direction away from the plug-in orifice 130. An encircling bellows vertex 168a, which connected the conical bellows folds 168b and 168c with one another, forms a constriction of the conducting route 150 with a narrowest cross-section with the cross-sectional area Q1. The cross-sectional areas Q1 of the first and the second embodiment do not have to match quantitatively.

The structure section 168 proceeds completely radially inside through the magnet arrangement 126 and engages it behind on its side which faces towards the outlet port with detents 168d. The magnet arrangement 126 can thus be held positively in a locked engagement between the support structure 118a and the detents 168d at the inner wall component 118. The structure section 168 completely screens the radially inner side of the magnet arrangement 126 physically.

Unlike the depiction in FIG. 2, the region of the structure section 168 carrying the detents 168d can be slotted and/or segmented respectively, in order to provide radial mobility of the detents 168d in such a way that they can be displaced radially inward by the material of the magnet arrangement 126 against their material prestressing for the arrangement of the magnet arrangement 126.

Since the sealing structure is formed by the bellows vertex 168a, a separate sealing component can be dispensed with in the second embodiment.

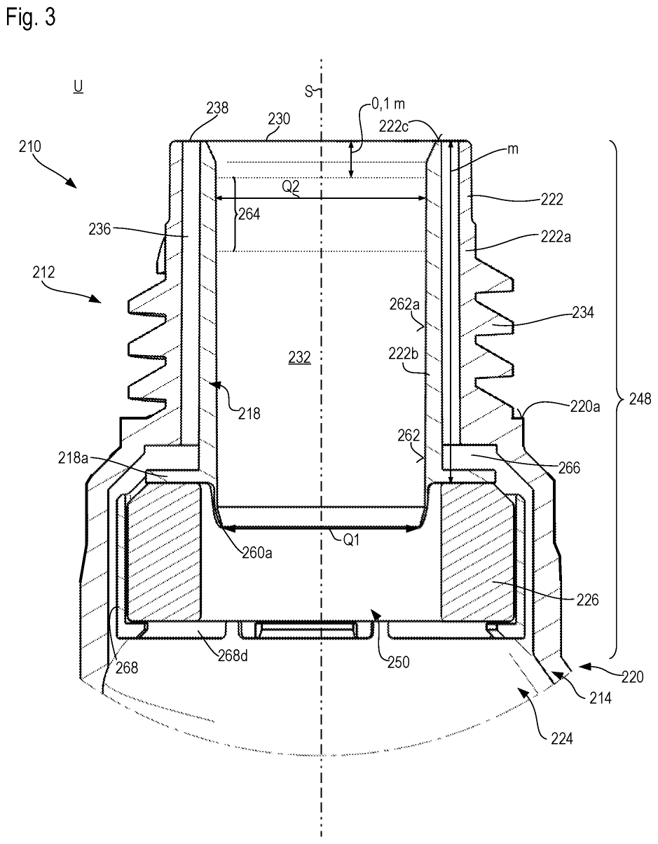

FIG. 3 depicts in rough schematic form a third embodiment of the invention's filling head 210 in longitudinal section. Identical and functionally identical components and component sections as in the first and second embodiments are labeled in the third embodiment with identical reference labels, but increased numerically by 200 or 100, respectively. The third embodiment shall be described hereunder only in so far as it differs from the first two embodiments, to whose description otherwise reference is made expressly also for elucidating the third embodiment.

In the third embodiment, similarly to the first embodiment, a sealing lip 260a is configured at the inner wall component 218. In contrast to the first embodiment, the sealing lip 260a is configured integrally with the inner wall component 218, in particular with the support section 218a, and is fabricated by injection molding together with the inner wall component 218.

Like the second embodiment, the inner wall component 218a also exhibits a structure section 268 proceeding past the magnet arrangement 226 over the entire axial extension of the magnet arrangement 226. In contrast to the second embodiment, however, the structure section 268 proceeds radially outside past the magnet arrangement 226 and encloses it. In the circumferential direction the structure section 268 is segmented in order to provide adequate elastic mobility of the detents 268d, such that on the arrangement of the magnet arrangement 226 at the structure section 268 they can be displaced radially outward by the magnet arrangement 226 against their material prestressing.

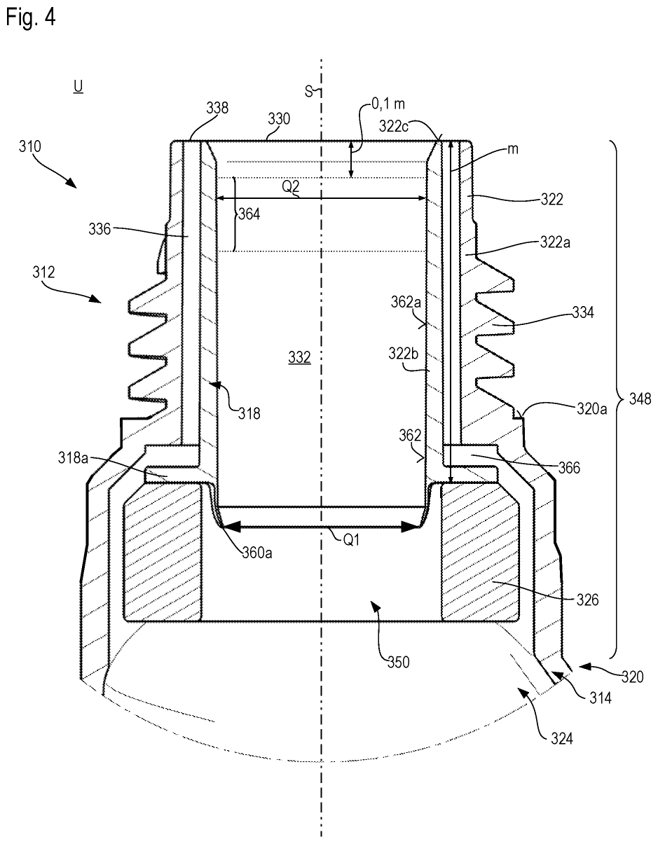

FIG. 4 depicts in rough schematic form a fourth embodiment of the invention's filling head 310 in longitudinal section. Identical and functionally identical components and component sections as in the first three embodiments are labeled in the fourth embodiment with identical reference labels, but increased numerically by 300 or 200 or 100, respectively. The fourth embodiment shall be described hereunder only in so far as differs from the first three embodiments, to whose description otherwise reference is made expressly also for elucidating the fourth embodiment.

The fourth embodiment of FIG. 4 corresponds essentially to the third embodiment of FIG. 3, with the exception that the inner wall component 318 does not exhibit a structure section. The magnet arrangement 326 is therefore neither radially inside nor radially outside penetrated and/or surrounded by a support section. The magnet arrangement 326 can then be fixed axially between the support structures 318a and 328b (not depicted).

In other words: The fourth embodiment of FIG. 4 corresponds essentially to the first embodiment of FIG. 1, with the difference that the sealing lip 360a is configured integrally with the inner wall component 118.

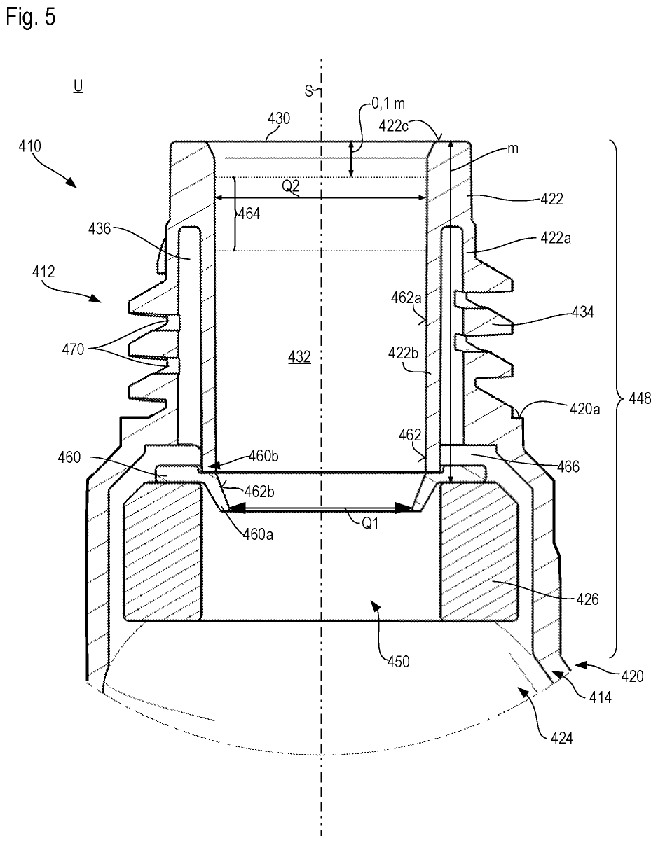

FIG. 5 depicts in rough schematic form a fifth embodiment of the invention's filling head 410 in longitudinal section. Identical and functionally identical components and component sections as in the first four embodiments are labeled in the fifth embodiment with identical reference labels, but increased numerically by 400 or 300 or 200 or 100, respectively. The fifth embodiment shall be described hereunder only in so far as it differs from the first four embodiments, to whose description otherwise reference is made expressly also for elucidating the fifth embodiment.

The fifth embodiment in FIG. 5 corresponds essentially to the first embodiment of FIG. 1, with the first exception that the inner wall structure 422b is formed integrally connected with the outer wall structure 422a. An inner wall component configured separately from the rest of the plug-in nozzle, therefore, is not present.

Because of the one-piece configuration of the entire plug-in nozzle 422, the inner wall structure 422b of the plug-in nozzle 422 forming the inner wall does not exhibit a support structure projecting radially outward against which the magnet arrangement 426 could abut two-dimensionally. Such a design would probably not be demoldable.

The separately configured sealing component 460 with the sealing lip 460a configured thereon is supported on the end face of the magnet arrangement 426 facing towards the plug-in orifice 430 and is supported in the opposite direction by the inner end face facing towards the magnet arrangement 426 of the inner wall structure 422b forming the inner wall. The sealing component 460 can exhibit a corresponding recess 460b, into which the inner end face of the inner wall structure 422b forming the inner wall dips.

The channel arrangement 436 does not extend up to the end wall 422c of the plug-in nozzle 422, but instead ends as an annular blind recess in the material of the plug-in nozzle 422 axially between the end wall 422c and the outer thread 434. The axial depth of the extension of the channel arrangement 436 can differ from the depiction in FIG. 5 and can in particular be shorter, i.e. for example end in the region of the outer thread 434 or at the longitudinal end of the outer thread 434 located nearer to the plug-in orifice 430.

For venting, radial openings 470 are provided which extend from the base of the outer thread 434 to the channel arrangement 436, thus connecting the channel arrangement 436 with the external environment U. At the outer wall of the plug-in nozzle 422 there is a larger area available for connecting the channel arrangement 436 with the external environment U than at the end wall 422c. A cap screwed onto the outer thread 434 closes off the radial openings 470, thus protecting the content of the tank T against gradually drying out through the venting structure, comprising the venting line 58, the main volume 424, the annular chamber 466, the channel arrangement 436, and the radial openings 470.

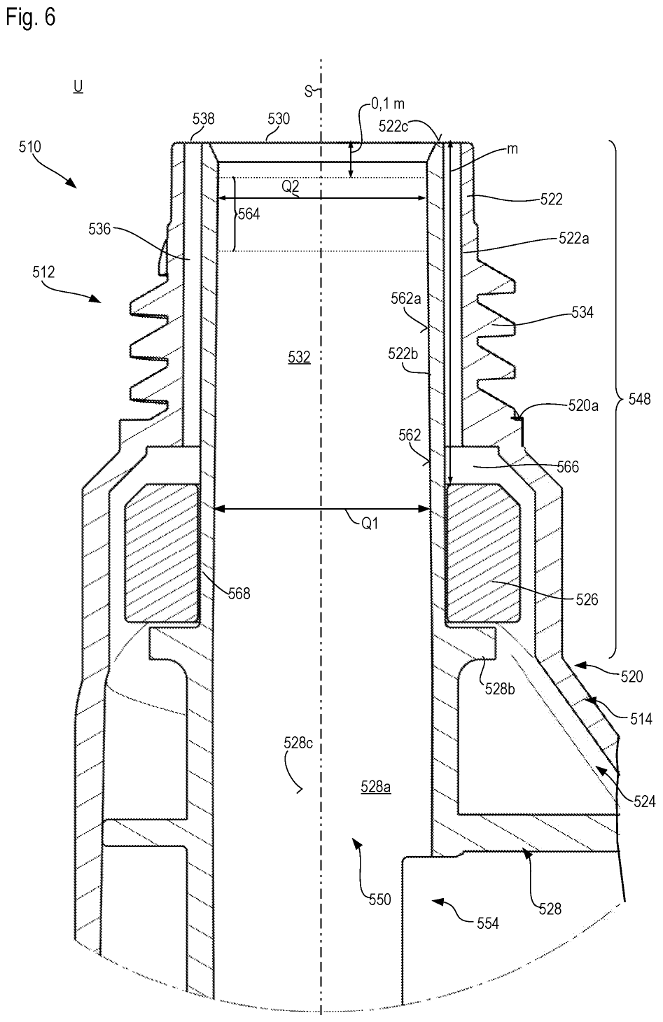

FIG. 6 depicts in rough schematic form a sixth embodiment of the invention's filling head 510 in longitudinal section. Identical and functionally identical components and component sections as in the first five embodiments are labeled in the sixth embodiment with identical reference labels, however increased numerically by 500 or 400 or 300 or 200 or 100, respectively. The sixth embodiment shall be described hereunder only in so far as it differs from the first five embodiments, to whose description otherwise reference is made expressly also for elucidating the sixth embodiment.

In the sixth embodiment, the inner wall structure 522b exhibiting the inner wall of the plug-in nozzle is formed by an inner wall component configured separately from the housing component 514 forming the outer wall structure 522a with the outer wall. The inner wall component is here the flow-guiding component 528.

Although a sealing structure can be configured at the the flow-guiding component 528 in the axial extension region of the magnet arrangement 526, for example through two-component injection molding, in the present embodiment example the inner wall structure 522b is so configured that the cross-sectional area Q1 is quantitatively and shape-wise approximately equal to the cross-sectional area Q2, such that the cross-sectional area Q1 is at least no greater than the cross-sectional area Q2. Given an appropriate radial measurement of the inner wall, there remains at the delivery device accommodated in the accommodating space 532 a radial gap not exceeding 0.5 mm gap width. In reality, this gap width is too small for venting flow to be able develop during a delivery process in the gap thus configured. The flow resistance in the narrow gap space is so much greater than in the channel arrangement 536, that in effect there is sealing of the accommodating space 532 in the axial extension region of the magnet arrangement 526.

As in the preceding and following embodiments also, the channel arrangement is the only flow connection with the external environment U for displaced gas.

The magnet arrangement 526 can, before mounting the plug-in nozzle, be slipped over the tubular inner wall structure 522b, which at its inner side forms the inner wall of the plug-in nozzle 522. The inner wall structure 522b centers the magnet arrangement 526. The support structure 528b forms an end stop for the magnet arrangement 526 and positions it axially.

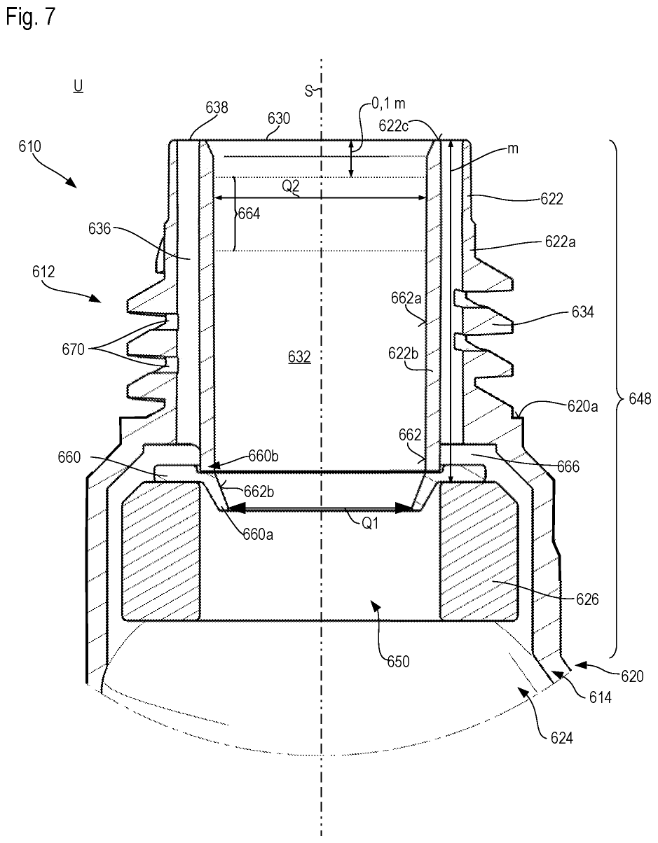

FIG. 7 depicts in rough schematic form a seventh embodiment of the invention's filling head 610 in longitudinal section. Identical and functionally identical components and component sections as in the first six embodiments are labeled in the seventh embodiment with identical reference labels, but increased numerically by 600 or 500 or 400 or 300 or 200 or 100, respectively. The seventh embodiment shall be described hereunder only in so far as it differs from the first six embodiments, to whose description otherwise reference is made expressly also for elucidating the seventh embodiment.

The seventh embodiment largely corresponds to the fifth embodiment of FIG. 5, with the difference that the channel arrangement 636 also leads into openings 638 in the end wall 622c. The radial openings 670 are additionally available. A cap screwed onto the plug-in nozzle can close off both the radial openings 76 and the openings 638 in the end wall 620c.

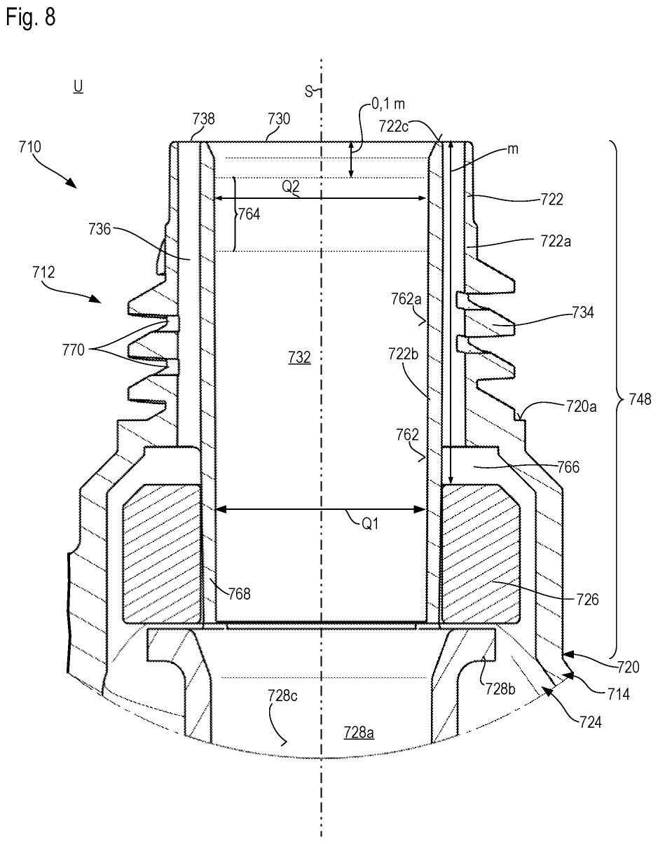

FIG. 8 depicts in rough schematic form an eighth embodiment of the invention's filling head 710 in longitudinal section. Identical and functionally identical components and component sections as in the first seven embodiments are labeled in the eighth embodiment with identical reference labels, but increased numerically by 700 or 600 or 500 or 400 or 300 or 200 or 100, respectively. The eighth embodiment shall be described hereunder only in so far as it differs from the first seven embodiments, to whose description otherwise reference is made expressly also for elucidating the eighth embodiment.

The closest to the eighth embodiment is the seventh embodiment of FIG. 7. Once again, the inner wall structure 722b implementing the inner wall is configured integrally at the housing component 714 with the outer wall structure 722a implementing the outer wall.

Unlike the seventh embodiment, the eighth embodiment does not comprise a sealing component. As in the sixth embodiment of FIG. 6, the inner wall structure 722b forming the inner wall proceeds radially inside through the magnet arrangement 726 axially up to the end face of the magnet arrangement facing towards the outlet port. As in the sixth embodiment, the cross-sectional areas Q1 and Q2 of the eighth embodiment are approximately equal in size. The discussion regarding the blocking of venting flow in the gap space between a delivery device and the structure with the boundary surface 562 radially opposite the delivery device in the context of the sixth embodiment, applies unchanged to the gap space between a delivery device introduced into the accommodating space 732 and the inner wall radially opposite to it in the eighth embodiment.

While considerable emphasis has been placed on the preferred embodiments of the invention illustrated and described herein, it will be appreciated that other embodiments, and equivalences thereof, can be made and that many changes can be made in the preferred embodiments without departing from the principles of the invention. Furthermore, the embodiments described above can be combined to form yet other embodiments of the invention of this application. Accordingly, it is to be distinctly understood that the foregoing descriptive matter is to be interpreted merely as illustrative of the invention and not as a limitation.

1-15. (canceled)

16. A filling head for introducing operating fluid into an operating fluid tank of a motorized vehicle and for venting the operating fluid tank when introducing operating fluid into it, where the filling head comprises:
A filling head housing where the filling head housing exhibits a delivery-accommodation region, which is configured for temporally transient accommodation of various delivery devices, such as for instance a spigot and a storage container neck,
Where the filling head housing is configured for transmitting operating fluid in a delivery sense from the delivery-accommodation region along an operating fluid delivery route to an outlet port of the filling head housing arranged in the delivery sense downstream of the delivery-accommodation region,
A venting structure, which during a transmission of operating fluid through the filling head housing in the delivery sense allows a transmission of gas in a venting sense that is opposite to the delivery sense,
Where the delivery-accommodation region of the filling head exhibits a plug-in nozzle extending along a virtual nozzle path with a plug-in orifice, through which an accommodating space for temporally transient accommodation of the delivery device is accessible, where the accommodating space is connected fluid-mechanically with the outlet port,
Where the nozzle path defines axial directions proceeding along the nozzle path, radial directions proceeding orthogonally to it, and circumferential directions proceeding around it,
Where in the filling head housing, at an axial magnet distance from the plug-in orifice, a magnet arrangement is arranged whose magnetic field acts on the operating fluid delivery route,
Where the venting structure comprises a channel arrangement, which at least along an axial section of the plug-in nozzle is bounded radially inwards by an inner wall structure with an inner wall of the plug-in nozzle facing towards the accommodating space and radially outwards by an outer wall structure with an outer wall of the plug-in nozzle facing away from the accommodating space,
Where from the plug-in orifice there proceeds as far as and into the axial extension region of the magnet arrangement a gas-impermeable boundary surface formed at least also by the inner wall and bounding the accommodating space radially outwards, where a cross-sectional area enclosed by the boundary surface and orthogonal to the nozzle path is at least not larger in a region of the boundary surface located in the extension region of the magnet arrangement than in a reference region located between the magnet arrangement and the plug-in orifice, where the reference region begins at an axial distance of 10% of the magnet distance from the plug-in orifice and ends at an axial distance not exceeding 50% of the magnet distance from the plug-in orifice.

17. The filling head according to claim 16, wherein the cross-sectional area is smaller in the extension region of the magnet arrangement than in the reference region.

18. The filling head according to claim 17, wherein in the extension region of the magnet arrangement there is provided a sealing structure projecting radially inward towards the nozzle path and encircling the nozzle path.

19. The filling head according to claim 16, wherein in the extension region of the magnet arrangement there is provided a sealing structure projecting radially inward towards the nozzle path and encircling the nozzle path.

20. The filling head according to claim 16, wherein at least one section of the inner wall structure of the plug-in nozzle is configured integrally with at least one section of the outer wall structure of the plug-in nozzle.

21. The filling head according to claim 16, wherein at least one section of the inner wall structure of the plug-in nozzle is configured as a separate inner wall component separate from at least one section of the outer wall structure of the plug-in nozzle.

22. The filling head according to claim 21, wherein in the filling head housing, in the region between the magnet arrangement and the outlet port, there is arranged a flow-guiding component with a flow-guiding wall proceeding along the operating fluid delivery route, where the inner wall structure is configured integrally with the flow-guiding component.

23. The filling head according to claim 22, wherein in the extension region of the magnet arrangement there is provided a sealing structure projecting radially inward towards the nozzle path and encircling the nozzle path and wherein the sealing structure is configured integrally with the inner wall structure of the plug-in nozzle, or that the sealing structure is configured at a sealing component configured separately from the plug-in nozzle.

24. The filling head according to claim 20, wherein in the extension region of the magnet arrangement there is provided a sealing structure projecting radially inward towards the nozzle path and encircling the nozzle path and wherein the sealing structure is configured integrally with the inner wall structure of the plug-in nozzle, or that the sealing structure is configured at a sealing component configured separately from the plug-in nozzle.

25. The filling head according to claim 23, wherein the sealing structure is formed by a sealing lip projecting radially inward or by a vertex section projecting radially inward of a bellows structure.

26. The filling head according to claim 19, wherein the sealing structure is formed by a sealing lip projecting radially inward or by a vertex section projecting radially inward of a bellows structure.

27. The filling head according to claim 16, wherein a structure section connected with the inner wall structure of the plug-in nozzle extends over the entire axial length of the magnet arrangement.

28. The filling head according to claim 27, wherein the structure section embraces the magnet arrangement at least at one axial longitudinal end of the magnet arrangement.

29. The filling head according to claim 16, wherein the plug-in nozzle exhibits in the region of the plug-in orifice a front surface surrounding the plug-in orifice, where the channel arrangement leads into the front surface.

30. The filling head according to claim 16, wherein the channel arrangement at an axial distance from the plug-in orifice leads into an outer wall formed by the outer wall structure of the plug-in nozzle.

31. The filling head according to claim 16, wherein at the outer wall structure of the plug-in nozzle there is provided an outer thread.

32. The filling head according to claim 31, wherein the outer thread is configured to interact with an inner thread of at least one filling head cap covering the delivery device for its positional stabilization at the plug-in nozzle and/or with a filling head cap covering the plug-in orifice.

33. The filling head according to claim 32, wherein the channel arrangement at an axial distance from the plug-in orifice leads into an outer wall formed by the outer wall structure of the plug-in nozzle and wherein at the base of the outer thread there is provided at least one opening, by means of which the channel arrangement leads into the outer wall.

34. The filling head according to claim 16, wherein the channel arrangement is connected fluid-mechanically only radially outside past the magnet arrangement with an inner volume of the filling head housing located on the side of the magnet arrangement facing towards the outlet port.
